(19) United States
(12) Patent Application Publication
(10) Pub. No.: US 2024/0161719 A1
(43) Pub. Date: May 16, 2024

(54) STRING INSTRUMENT WITH A SHOVEL-TYPE BODY FOR IMPROVED SOUND

(71) Applicant: Jack L. Akins, Coffeeville, AL (US)

(72) Inventor: Jack L. Akins, Coffeeville, AL (US)

(21) Appl. No.: 18/507,856

(22) Filed: Nov. 13, 2023

Related U.S. Application Data
(60) Provisional application No. 63/383,789, filed on Nov. 15, 2022.

(51) Int. Cl. G10D 3/22; G10D 3/06

(52) U.S. Cl. CPC G10D 3/22; G10D 3/06

(57) ABSTRACT

Various implementations include a string instrument. The instrument includes a neck, a bridge, and a body. The neck has a first neck end and a second neck end opposite and spaced apart from the first neck end. The body is coupled to the first neck end. The body includes a metal plate. The metal plate has a first side and a second side opposite and spaced apart from the first side. The first side has a convex surface, and the second side has a concave surface.

### BACKGROUND

Guitars are a stringed instrument that have been around for centuries. Over the years guitars have grown and developed to produce a variety of different variations such as bass guitars and electric guitars. Each type of guitar comes with its own unique sound that depends on its shape and various pickup positions for electric guitars. Each guitar further attempts to create a unique shape and design to stand out from other guitars made before, turning into a functional piece of art.

### SUMMARY

Various implementations include a string instrument. The instrument includes a neck, a bridge, and a body. The neck has a first neck end and a second neck end opposite and spaced apart from the first neck end. The body is coupled to the first neck end. The body includes a metal plate. The metal plate has a first side and a second side opposite and spaced apart from the first side. The first side has a convex surface, and the second side has a concave surface.

In some implementations, the bridge is coupled to the first side of the metal plate.

In some implementations, the instrument further includes a tailpiece coupled to the first side of the metal plate.

In some implementations, the instrument further includes one or more pickups. In some implementations, the one or more pickups are coupled to the first side of the metal plate. In some implementations, the one or more pickups include two or more pickups. In some implementations, the two or more pickups include three or more pickups. In some implementations, the one or more pickups include one or more single-coil pickups. In some implementations, the one or more pickups include one or more humbucker pickups.

In some implementations, the metal plate has a longitudinal axis that is parallel to a longitudinal axis of the neck. in some implementations, the first side of the metal plate is convex as viewed in a plane perpendicular to the longitudinal axis of the metal plate. In some implementations, the second side of the metal plate is concave as viewed in the plane perpendicular to the longitudinal axis of the metal plate.

In some implementations, the metal plate includes hardened steel. In some implementations, the metal plate includes at least a portion of the head of a shovel. In some implementations, the body further includes wood.

In some implementations, the instrument further includes one or more strings extending from the second neck end to the body. In some implementations, the one or more strings includes four or more strings. In some implementations, the four or more strings includes six or more strings.

In some implementations, the instrument is configured to induce vibrations in the metal plate.

In some implementations, the instrument further includes one or more capacitors. In some implementations, the one or more capacitors includes three or more capacitors. In some implementations, the three or more capacitors include a 0.022 μF capacitor, a 0.033 μF capacitor, and a 0.046 μF capacitor.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of a string instrument, according to one implementation.

FIG. 2 is a front view of the string instrument of FIG. 1.

FIG. 3 is a rear view of the string instrument of FIG. 1.

FIG. 4 is a right-side view of the string instrument of FIG. 1.

FIG. 5 is a left-side view of the string instrument of FIG. 1.

FIG. 6 is a top view of the string instrument of FIG. 1.

FIG. 7 is a bottom view of the string instrument of FIG. 1.

FIG. 8 is a top perspective view of the string instrument of FIG. 1.

FIG. 9 is a left-side perspective view of the string instrument of FIG. 1.

FIG. 10 is a bottom perspective view of the string instrument of FIG. 1.

FIG. 11 is a top perspective view of a string instrument, according to another implementation.

FIG. 12 is a left-side perspective view of the string instrument of FIG. 11.

FIG. 13 is a bottom perspective view of the string instrument of FIG. 11 with the back plate removed so that the electronics inside the instrument can be seen.

FIG. 14 is a top perspective view of a string instrument, according to another implementation.

FIG. 15 is a rear view of the string instrument of FIG. 14.

FIG. 16 is a top perspective view of the string instrument of FIG. 14 with the front plate removed so that the electronics inside the instrument can be seen.

FIG. 17 is a top perspective view of a string instrument, according to another implementation.

FIG. 18 is another top perspective view of the string instrument of FIG. 17.

FIG. 19 is a left-side perspective view of the string instrument of FIG. 17.

FIG. 20 is a top perspective view of a string instrument, according to another implementation.

FIG. 21 is a left-side perspective view of the string instrument of FIG. 20.

### DETAILED DESCRIPTION

The devices, systems, and methods disclosed herein provide for a string instrument having a body that includes a shovel head portion. The vibrations produced by the strings of the string instrument resonate in the metal of the shovel head portion of the body to provide users with an instrument that provides a unique design and sound. The devices disclosed herein include a guitar, bass, fiddle, or other string instrument. The instrument includes a head, a neck, and a body that includes the shovel head portion.

The metal shovel head portion of the instruments disclosed herein can actually be made from the head of a shovel or can be manufactured to resemble the shape and characteristics of the head of a shovel. The metal shovel heads have a thickness that resonates a pure sound. The instruments disclosed herein comprise a head that secures and tunes a plurality of guitar strings. Further, the neck allows for the plurality of guitar strings to resonate various sounds. Additionally, the body secures the plurality of guitar strings at another end.

Various implementations include a string instrument. The instrument includes a neck, a bridge, and a body. The neck has a first neck end and a second neck end opposite and spaced apart from the first neck end. The body is coupled to the first neck end. The body includes a metal plate. The metal plate has a first side and a second side opposite and spaced apart from the first side. The first side has a convex surface, and the second side has a concave surface.

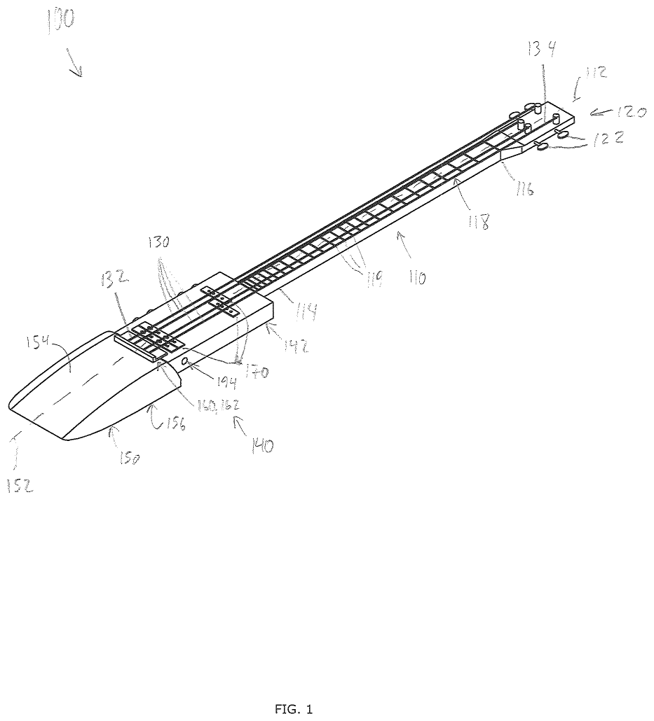

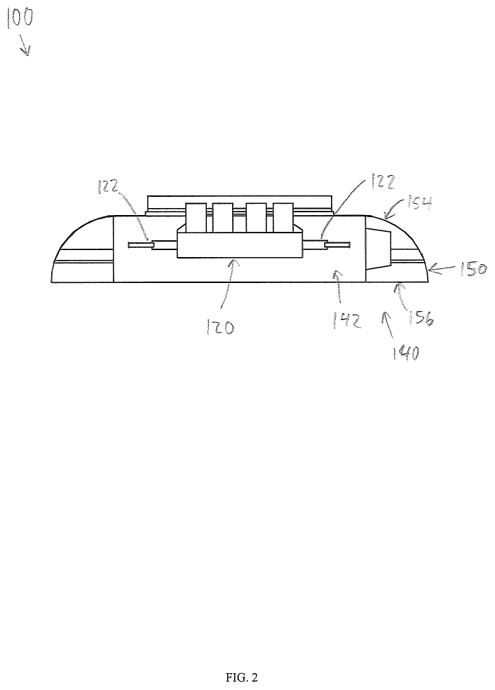

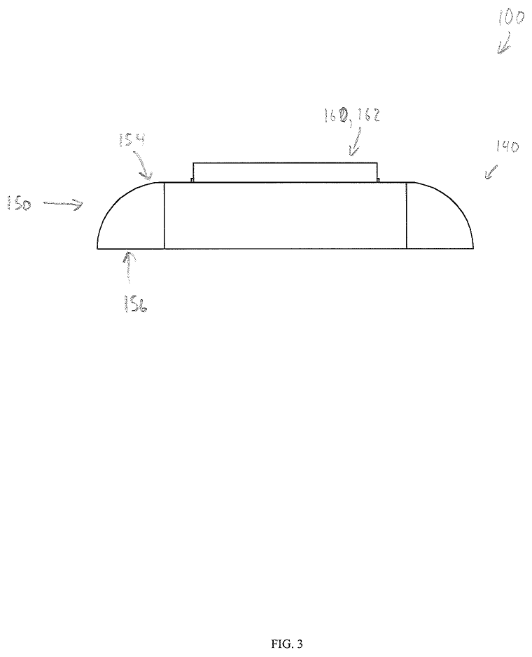

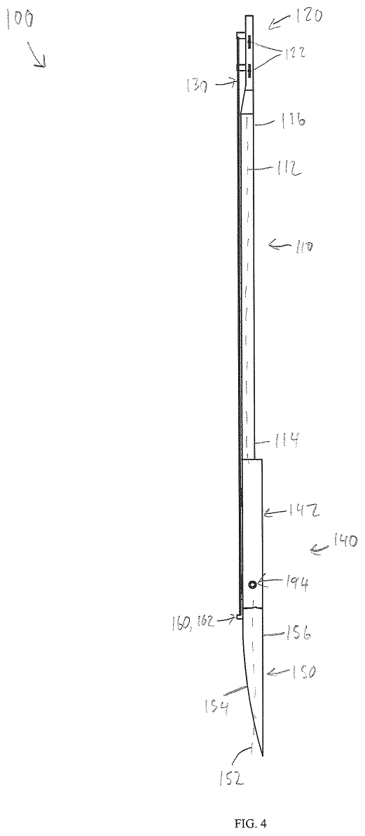

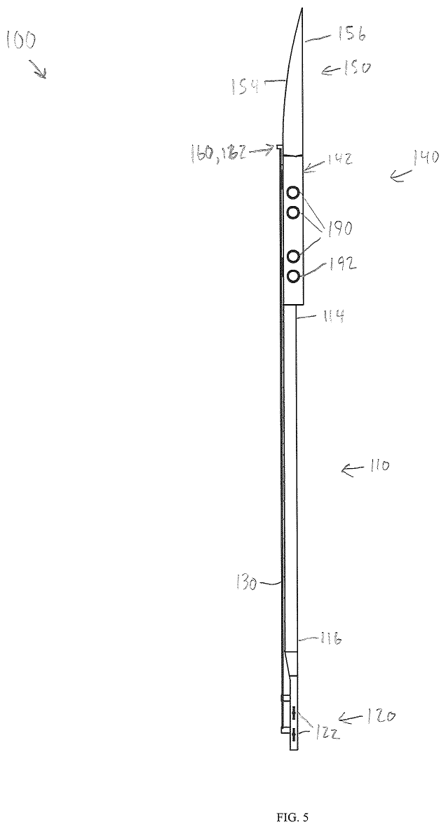

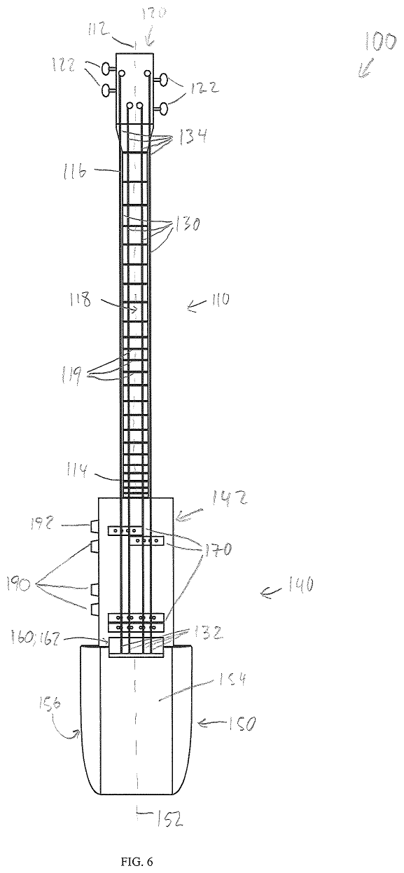

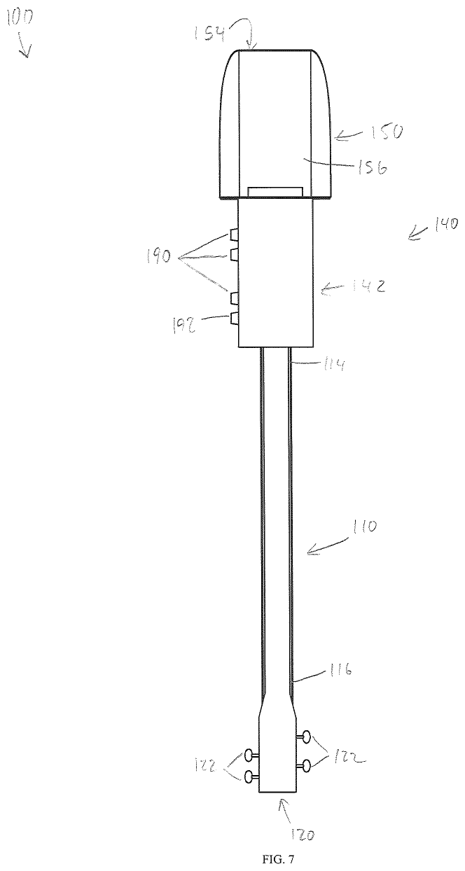

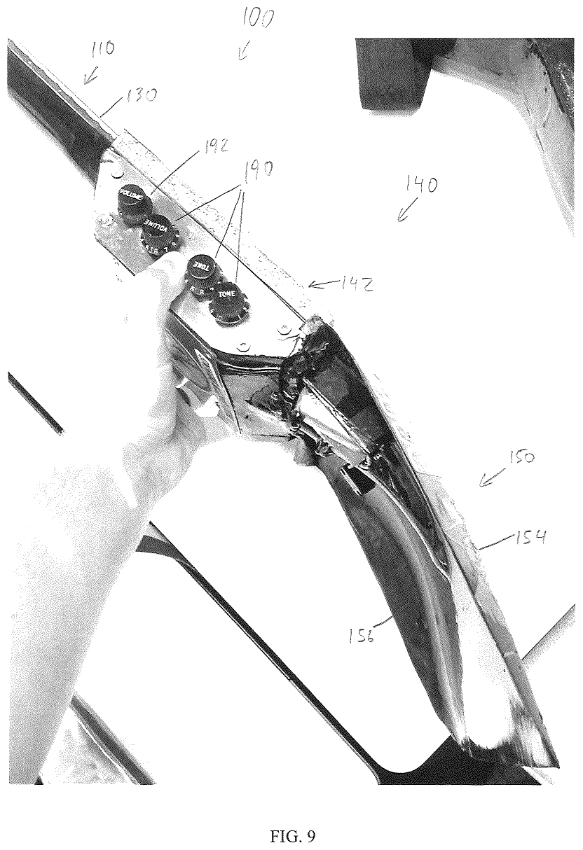

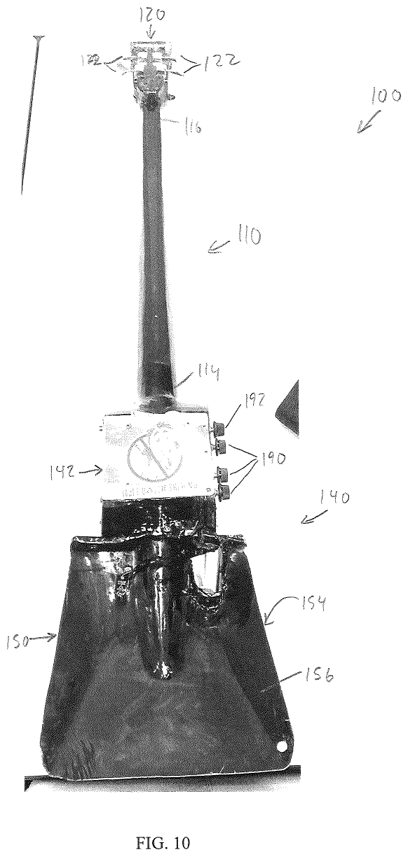

FIGS. 1-10 show a string instrument 100 according to one implementation. The instrument 100 includes a neck 110, a head 120, strings 130, a body 140, a bridge 160, a tailpiece 162, pickups 170, electronics, and controls.

The neck 110 has a longitudinal axis 112, a first neck end 114, and a second neck end 116 opposite and spaced apart from the first neck 114 end along the longitudinal axis 112 of the neck 110. The neck 110 further includes a fretboard 118 extending between the first neck end 114 and the second neck end 116. The fretboard 118 includes a plurality of frets 119 spaced apart from each other along the longitudinal axis 112 of the neck 110.

The head 120 is coupled to the second neck end 116. The head 120 includes a plurality of tuners 122.

Each of the strings 130 has a first string portion 132 and a second string portion 134 longitudinally spaced apart from the first string portion 132. The second string portion 134 of each string 130 is coupled to a separate one of the plurality of tuners 122 of the head 120. The plurality of tuners 122 are used to individually tension the string 130 to which the tuner 122 is coupled.

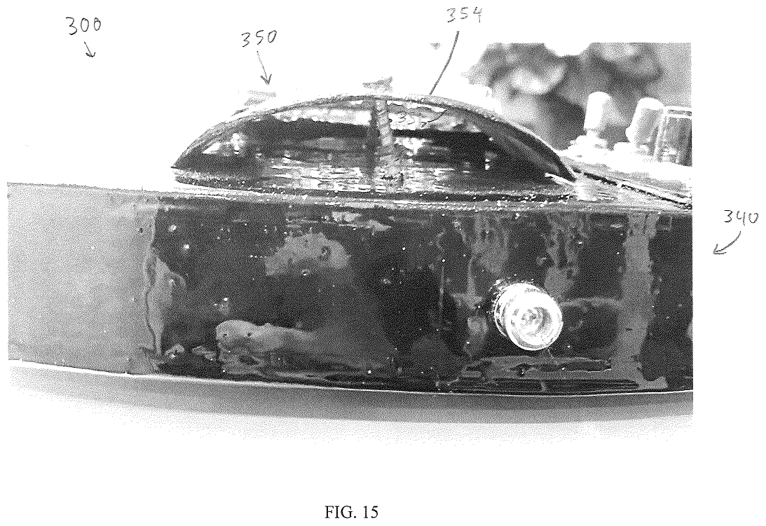

The body 140 is coupled to the first neck end 114. The body 140 includes a wooden portion 142 and a metal plate 150. The metal plate 150 has a longitudinal axis 152, a first side 154, and a second side 156 opposite and spaced apart from the first side 154. The metal plate 150 is oriented such that the longitudinal axis 152 of the metal plate 150 is parallel to the longitudinal axis 112 of the neck 110. Similar to the first side 354 and second side 356 of the metal plate 350 of the instrument 300 shown in FIG. 15, the first side 154 of the metal plate 150 of the instrument 100 shown in FIGS. 1-10 has a convex surface as viewed in a plane perpendicular to the longitudinal axis 152 of the metal plate 150. The second side 156 of the metal plate 150 has a concave surface as viewed in the plane perpendicular to the longitudinal axis 152 of the metal plate 150. However, in some implementations, the first side of the metal plate has a convex surface in any plane, and the second side of the metal plate has a concave surface in any plane. In some implementations, the first side of the metal plate has a concave surface in any plane, and the second side of the metal plate has a convex surface in any plane. In some implementations, the first side of the metal plate has one or more convex surfaces in any plane and/or one or more concave surfaces in any plane, and the second side of the metal plate has one or more convex surfaces in any plane and/or one or more concave surfaces in any plane. In some implementations, the first side of the metal plate does not have a convex surface or a concave surface in any plane. In some implementations, the second side of the metal plate does not have a convex surface or a concave surface in any plane.

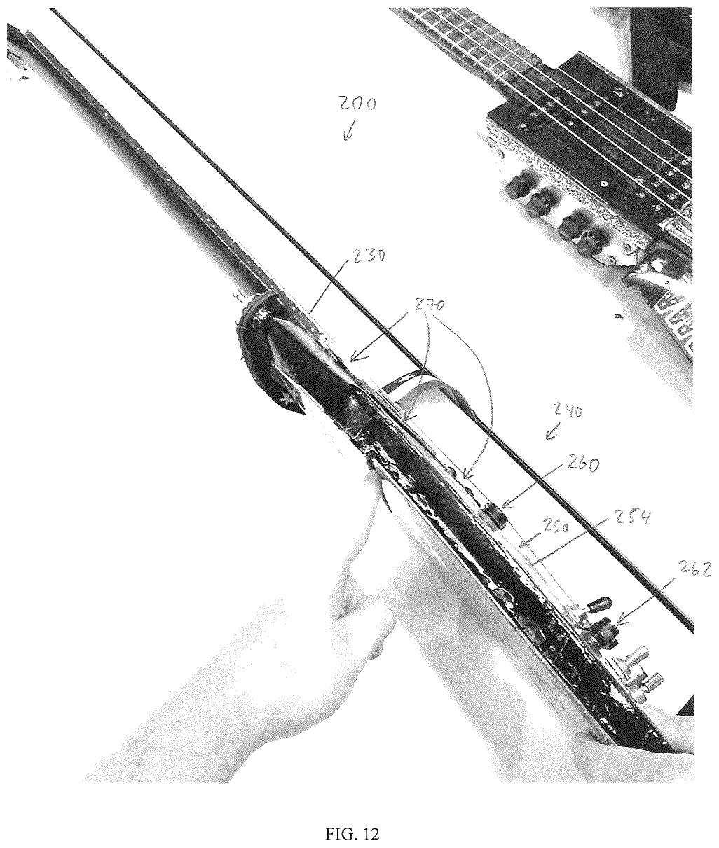

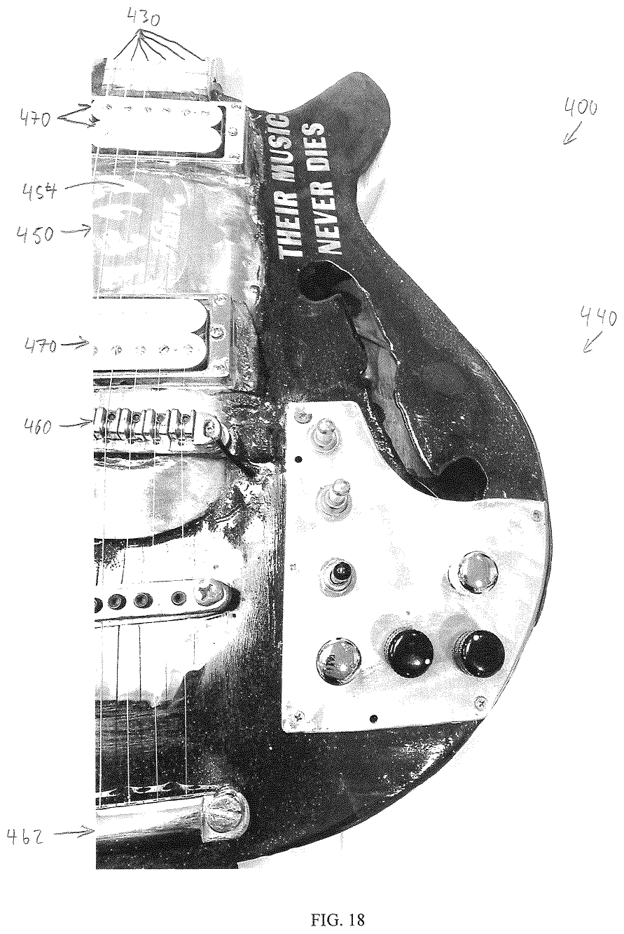

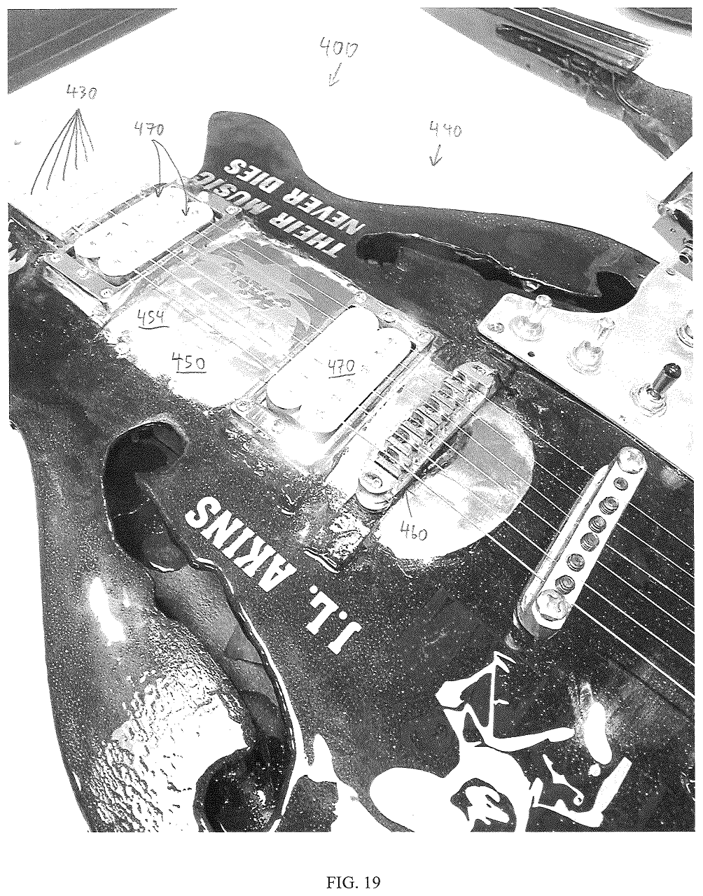

The metal plates 150, 250, 350, 450, 550 shown in FIGS. 1-21 are made from the head of a metal shovel. Thus, the first sides of the metal plates are the back side of the shovel head, and the second sides of the metal plates are the front side of the shovel head. Because the metal plate is made from a shovel head, the metal plate is made of hardened steel. However, in some implementations, the metal plate can be made of any other metal. In some implementations, the metal plate is not metal, and the plate includes any other material that has a similar hardness to hardened steel.

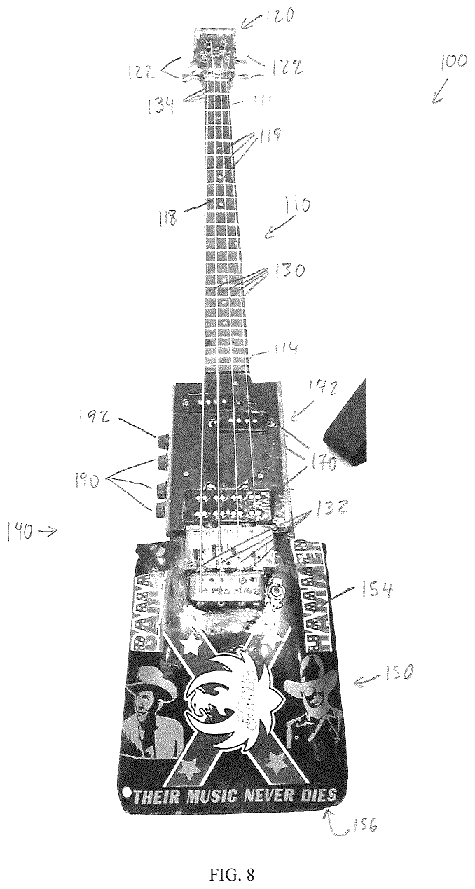

The bridge 160 is coupled to the first side 154 of the metal plate 150. The bridge 160 and the tailpiece 162 of the instrument 100 shown in FIGS. 1-7 are combined, but in some implementations, such as those shown in FIGS. 8-21, the tailpiece 262, 362, 462, 562 is separate from the bridge 260, 360, 460, 560.

The first string portion 132 of each of the plurality of strings 130 is coupled to the tailpiece 162. As noted above, the strings 130 can each be tensioned by the tuners 122 of the head 120 such that the strings 130 are tensioned between the head 120 and the tailpiece 162.

The bridge 160 supports the strings 130 on the instrument 100 and transmits the vibration of the strings 130 to the body 140. In implementations where the tailpiece 262, 362, 462, 562 is separate from the bridge 260, 360, 460, 560, the vibrations of the strings 230, 330, 430, 530 are also transferred to the body 240, 340, 440, 540 through the tailpiece 262, 362, 462, 562.

Because the bridge 160, 560 and tailpiece 162, 562 of the instruments 100, 500 in FIGS. 1-10, 20, and 21 are coupled to the first side 154, 554 of the metal plate 150, 550, the vibrations from the strings 130, 530 are transmitted directly to the metal plate 150, 550, causing the frequencies of the strings 130, 530 to resonate in the metal plate 150, 550. The shape and the material of the metal plate 150 create a unique sound as the vibrations of the strings 130 resonate in the metal plate 150.

The instruments 100, 200, 300, 400 shown in FIGS. 1-19 include three pickups 170, 270, 370, 470. The pickups 170 in FIGS. 1-10 include two single-coil pickups and one humbucker pickup. However, in some implementations, the instrument can include any number of pickups. In some implementations, the instrument can include any number of single-coil pickups, humbucker pickups, or any other type of pickups. In some implementations, the instrument is an acoustic instrument and does not include any pickups.

The pickups 170 each convert vibrations from the strings 130 into electricity. The pickups 170 include one or more magnetic poles that are wound by wires to form coils. Each of the one or more poles are located adjacent a separate one of the strings 130 of the instrument 100. The poles use electromagnetic induction to convert the mechanical vibrations of metal strings 130 into electrical signals, which can ultimately be sent to an amplifier (not shown).

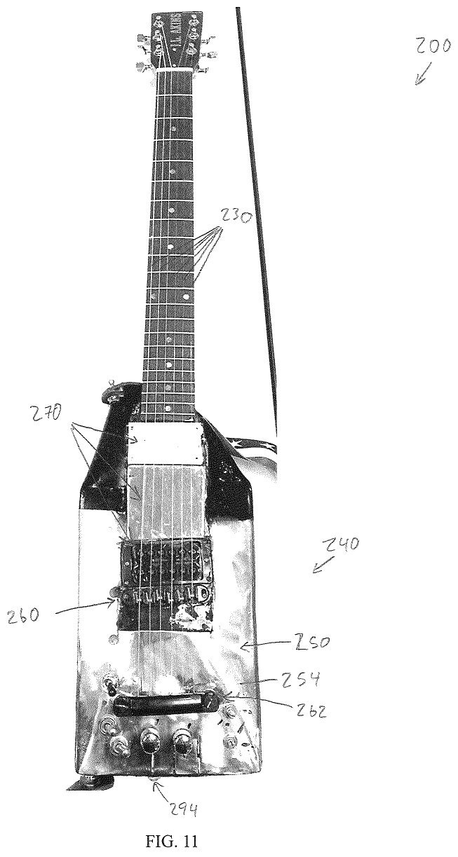

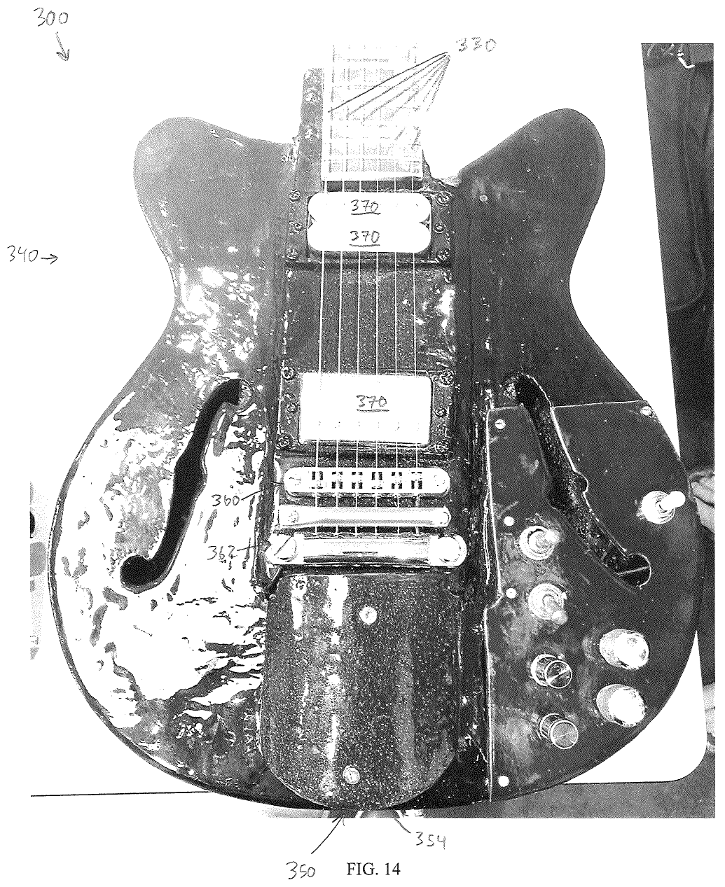

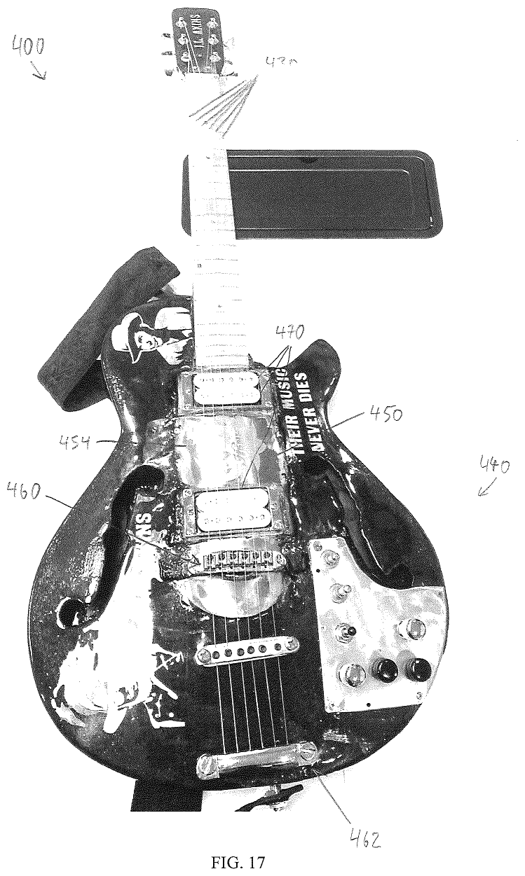

Although the bridge 160, 560 and the tailpiece 162, 562 of the instruments 100, 500 shown in FIGS. 1-10, 20, and 21 are directly coupled to the first side 154, 554 of the metal plate 150, 550, in some implementations, such as the instrument 200 in FIGS. 11-13, only the tailpiece 262 is directly coupled to the first side 254 of the metal plate 250. In some implementations, only the bridge is directly coupled to the metal plate. In some implementations, such as the instrument 400 in FIGS. 17-19, one or more of the pickups 470 can be directly coupled to the first side 454 of the metal plate 450. In some implementations, any combination of the bridge, the tailpiece, the pickups, or any other portion of the guitar that transfers vibrations of the strings to the body are coupled to the metal plate. In some implementations, such as the instrument 300 in FIGS. 14-16, no portion of the instrument 300 that transfers vibrations of the strings 330 to the body 340 is coupled to the first side 354 of the metal plate 350.

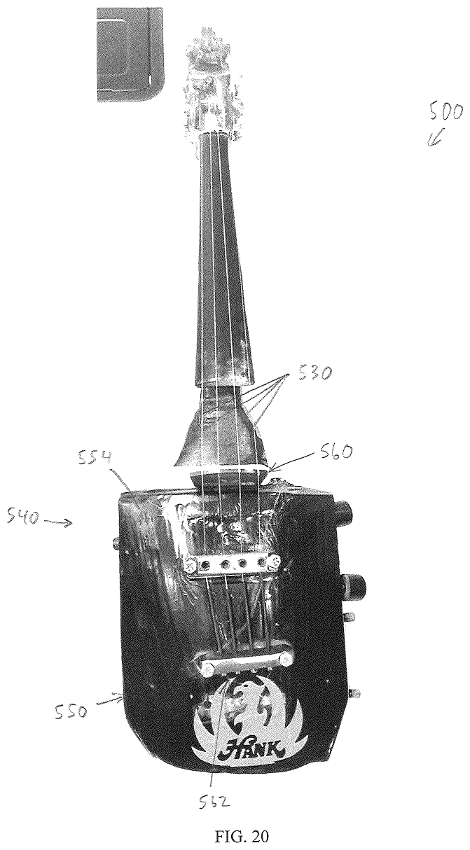

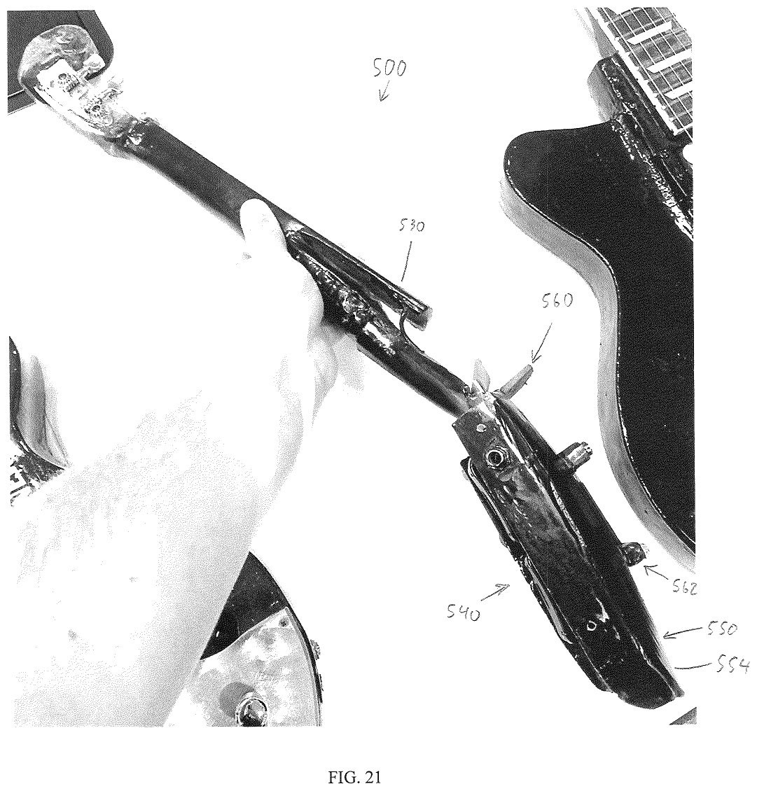

The instrument 100 shown in FIGS. 1-10 is an electric base having four strings 130. However, in some implementations, such as the instrument 500 in FIGS. 20 and 21, the instrument 500 can be a fiddle or violin having four strings 530. In some implementations, such as the instruments 200, 300, 400 shown in FIGS. 11-19, the instrument 200, 300, 400 is a guitar having six strings 230, 330, 430. In some implementations, the instrument is any other type of string instrument. In some implementations, the instrument includes any number of one or more strings.

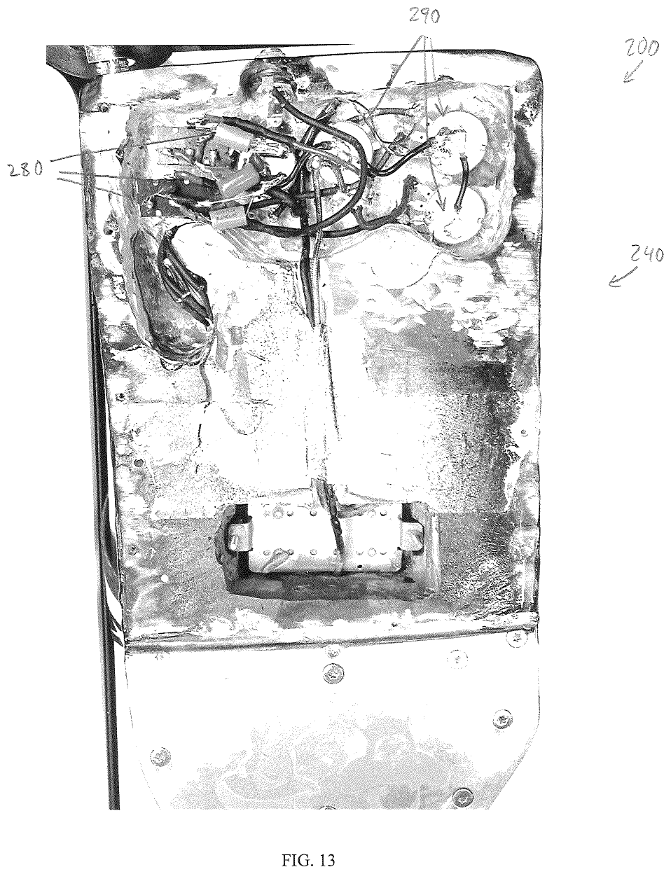

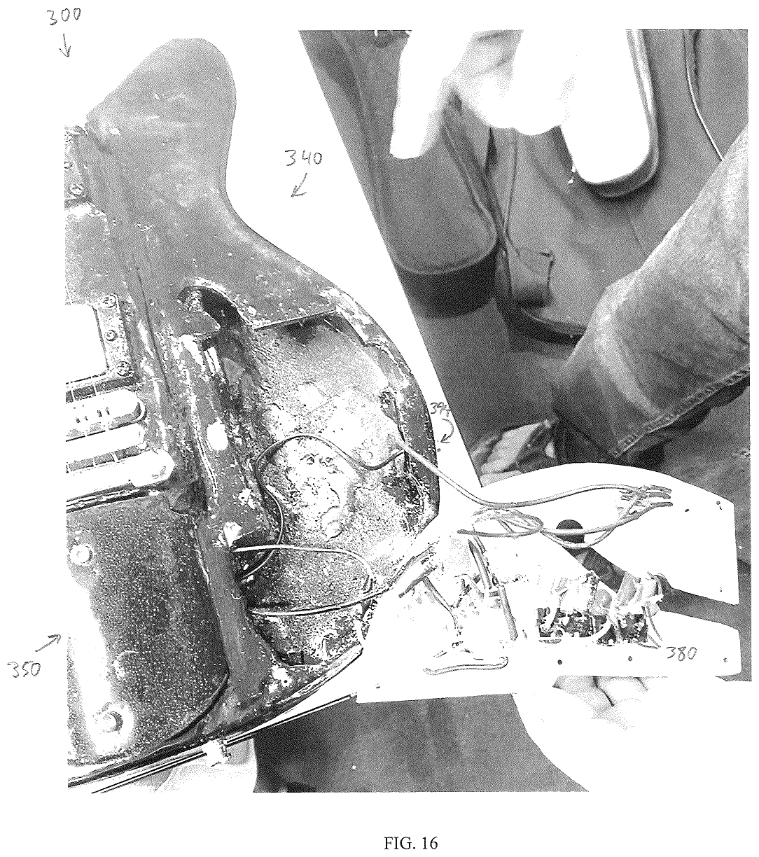

The instrument 100 can further include three capacitors. As shown in FIGS. 13 and 16, each of the three capacitors 280, 380 is connected to the pickups 270, 370 to limit or filter the range of frequencies produced by the pickups 270, 370. The capacitors 280, 380 essentially act as a low pass filter, only allowing frequencies lower than the cutoff frequency to pass to the input jack 294, 394 and grounding out any higher frequencies. The capacitors 280, 380 of the instruments 200, 300 shown in FIGS. 13 and 16 are a 0.022 μF capacitor, a 0.033 μF capacitor, and a 0.046 μF capacitor. Although the instruments 200, 300 shown in FIGS. 13 and 16 include three capacitors 280, 380, in some implementations, the instrument can include only one capacitor, two capacitors, or more than three capacitors. In some implementations, the capacitors can include one or more 0.10 μF capacitors, one or more 0.047 μF capacitors, or one or more of any other sized capacitors.

The instrument 100 shown in FIGS. 1-10 includes one or more control knobs or potentiometers (“pots”) 190 that can be used to select the capacitors to cause the instrument 100 to produce different tones. The instrument 100 also includes a volume control knob or pot 192 to change the amplitude of the electric sound signal to the input jack 194. The input jack 194 receives a jack cable (not shown) that is in electrical communication with an amplifier (not shown). The amplifier (not shown) is then in electrical communication with one or more speakers (not shown).

When one or more strings 130 of the instrument 100 are vibrated, the vibrations from the string 130 are transferred into the metal plate 150 of the body 140 of the instrument 100. The transferred vibrations in the metal plate 150 resonate at specific frequencies and durations to produce its own unique sound frequencies that are not found in common instrument strings alone. The frequencies from the strings 130 combined with the frequencies from the metal plate 150 induce an electrical signal in the coils of the one or more pickups 170. The frequency ranges of these electrical signals are then limited by the one or more capacitors to selectively filter the sound output of the instrument 100. The filtered electrical signal is then transferred through the input jack 194, through the jack cable (not shown), to the amplifier (not shown). The amplifier increases the energy of the signal before the signal is transferred to the one or more speakers (not shown), which convert the amplified signal to audible sound.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A string instrument, the instrument comprising:
a neck having a first neck end and a second neck end opposite and spaced apart from the first neck end;
a bridge; and
a body coupled to the first neck end, the body comprising a metal plate, the metal plate having a first side and a second side opposite and spaced apart from the first side, wherein the first side has a convex surface and the second side has a concave surface.

2. The instrument of claim 1, wherein the bridge is coupled to the first side of the metal plate.

3. The instrument of claim 1, further comprising a tailpiece, wherein the tailpiece is coupled to the first side of the metal plate.

4. The instrument of claim 1, further comprising one or more pickups.

5. The instrument of claim 4, wherein the one or more pickups are coupled to the first side of the metal plate.

6. The instrument of claim 4, wherein the one or more pickups comprises two or more pickups.

7. The instrument of claim 6, wherein the two or more pickups comprises three or more pickups.

8. The instrument of claim 4, wherein the one or more pickups comprises one or more single-coil pickups.

9. The instrument of claim 4, wherein the one or more pickups comprises one or more humbucker pickups.

10. The instrument of claim 1, wherein the metal plate has a longitudinal axis that is parallel to a longitudinal axis of the neck, wherein the first side of the metal plate is convex as viewed in a plane perpendicular to the longitudinal axis of the metal plate, wherein the second side of the metal plate is concave as viewed in the plane perpendicular to the longitudinal axis of the metal plate.

11. The instrument of claim 1, wherein the metal plate comprises hardened steel.

12. The instrument of claim 1, wherein the metal plate comprises at least a portion of the head of a shovel.

13. The instrument of claim 1, wherein the body further comprises wood.

14. The instrument of claim 1, further comprising one or more strings extending from the second neck end to the body.

15. The instrument of claim 14, wherein the one or more strings comprises four or more strings.

16. The instrument of claim 15, wherein the four or more strings comprises six or more strings.

17. The instrument of claim 1, wherein the instrument is configured to induce vibrations in the metal plate.

18. The instrument of claim 1, further comprising one or more capacitors.

19. The instrument of claim 18, wherein the one or more capacitors comprises three or more capacitors.

20. The instrument of claim 19, wherein the three or more capacitors comprise a 0.022 μF capacitor, a 0.033 μF capacitor, and a 0.046 μF capacitor.
